(19) United States
(12) Patent Application Publication
(10) Pub. No.: US 2018/0298664 A1
(43) Pub. Date: Oct. 18, 2018

(54) Door Drive Comprising a Main and Auxiliary Drive

(71) Applicant: ASSA ABLOY Sicherheitstechnik GmbH, Albstadt (DE)

(72) Inventors: Andreas Sauter, Messstetten (DE); Peter Rittinger, Benzingen (DE); Stefan Fischbach, Ochsenhausen (DE)

(21) Appl. No.: 15/569,494

(22) PCT Filed: Apr. 28, 2016
(86) PCT No.: PCT/EP2016/059476

§ 371 Date: Oct. 26, 2017

(30) Foreign Application Priority Data
Apr. 30, 2015 (DE) 10 2015 106 826.5
Apr. 30, 2015 (DE) 10 2015 106 827.3
Jan. 20, 2016 (DE) 10 2016 100 956.3
Jan. 20, 2016 (EP) PCT/EP2016/051168
Feb. 11, 2016 (DE) 10 2016 102 416.3
Mar. 15, 2016 (DE) 10 2016 104 770.8

(51) Int. Cl. E05F 3/10; E05F 15/63; E05F 1/10; E05F 5/02

(52) U.S. Cl. CPC E05F 3/10; E05F 15/63; E05F 2003/228; E05F 5/027; E05F 1/105

(57) ABSTRACT

Door drive for a door of a building with a door panel supported pivotably in a fixed door frame about a vertical door axis, in door hinges, with a main drive and an auxiliary drive.

The output of the drive unit of the auxiliary drive is or can be coupled to the slider and/or slide arm of the main drive via a coupling device connected in between in order to act on the slider and/or slide arm of the main drive at least in an end phase of the closing process and/or at least an initial phase of the opening process.

Manual door drives are known, e.g. from DE 37 42 213 A1, which have a drive unit with a power transmission device and are formed for mounting on doors with swing door panels. Depending on the local conditions and application, the drive unit is mounted on the panel side or the frame side. The power transmission device is supported on the opposite side, i.e. on the frame side or panel side. In this known manual door drive, the drive unit comprises a closing spring unit and a hydraulic damping device. The closing spring unit and the hydraulic damping device are taken up in a housing, in which the output shaft is also supported, to which the power transmission device is connected. This can be realised in practice as a scissor linkage device or a slide arm-slide rail device.

An electromechanical door drive, which is formed in a comparable manner from a drive unit and a corresponding power transmission device, is known e.g. from EP 1 505 239 Bl. The drive unit comprises an electric motor, the output shaft of which is connected to the power transmission device, which can be formed in the same manner as in the aforesaid manual door closer as a scissor linkage device or a slide arm-slide rail device. The electromechanical drive is mounted in a comparable manner on a door with swing door panels, as described above for the manual door closer.

A substantial function of the manual and electromechanical door drives is that, at the end of the closing process, the door must securely reach the closing position in the lock, overcoming the lock strike plate. On the known manual door closers with hydraulic damping, a so-called hydraulic end stop is normally provided for this, which consists in the hydraulic damping having a bypass in the end phase in the closing process. In practice this often causes the door to slam shut with a loud bang when the door falls into the lock. If the end stop is set more weakly, it can occur that the spring force of the closing spring at the end of the closing process is not sufficient to close the door, i.e. it can occur that the door does not reach the closing position, the lock strike plate is not overridden and the door panel merely remains ajar on the frame before reaching the closing position.

In the case of the known electromotive door drives, the motor opening and/or closing process can be controlled by an electric control device. However, for the drive to function reliably and safely, constant servicing and control adjustments are necessary. A failure of electrical components normally results in the complete stoppage of the drive, with the result that said servicing and checking measures are permanently required. Furthermore, the electric drive basically requires a power connection. Manual door drives are therefore frequently preferred in practice.

Furthermore, door closers and door dampers are also known that are used on doors in buildings and can only be coupled to the door during the closing and opening process close to the closing end position, and thus only act on the door in this partial range of the closing and opening process. These drive devices likewise have a drive unit to be mounted on the frame side or panel side with a power transmission device, which have, however, a linkage that can be engaged and disengaged automatically. A drive of this kind with automatically engageable and disengageable linkage is described in EP 2 468 998 A1. In a manner comparable with a manual hydraulic door closer, the drive unit has a spring mechanism with hydraulic damping device, which interacts with a slide arm on the output side, which arm automatically engages in or disengages from a slide rail during the opening and closing process.

U.S. Pat. No. 2,190,653 describes a conventional hydraulic door closer with scissor linkage in combination with a door closer that, as described, engages in and disengages from a pivot bearing automatically during the opening and closing process.

The object of the invention is to design a drive system composed of a main drive and an auxiliary drive such that the drive has a compact structure and confers advantages in operation on the door in respect of opening and/or closing movement.

The invention achieves this object with the subject of claim 1.

This door drive is a door drive for a door of a building with a door panel supported pivotably about a vertical door axis, preferably in door hinges, in a fixed door frame.

The door drive has a main drive and an auxiliary drive.

The main drive is formed to act on the door panel in terms of a closing movement and/or opening movement and/or closing damping and/or opening damping, preferably as a manual closing spring drive or as an electromotive door drive.

The main drive has a drive unit with an output and a power transmission device with a slide arm and a slide rail. The slide arm is drive-connected to the output of the drive unit. At its free end it has a slider, with which the slide arm is guided in the slide rail.

The auxiliary drive is formed for forming the door panel in terms of closing movement and/or opening movement and/or closing damping and/or opening damping. The auxiliary drive has a drive unit with an output.

The drive unit of the main drive can be mounted on the door panel and the slide rail on the door frame. However, reverse mounting is also possible, i.e. with the drive unit of the main drive on the door frame and the slide rail on the door panel.

It is substantial in the drive according to the invention that the output of the drive unit of the auxiliary drive is or can be coupled to the slider and/or slide arm of the main drive via an interconnected coupling device, in order to act on the slider and/or slide arm of the main drive at least in an end phase of the closing process and/or at least an initial phase of the opening process by the output of the auxiliary drive. The coupling device is preferably interconnected or interconnectable directly between the output of the drive unit of the auxiliary drive and the slider and/or the slide arm of the main drive, in order to act on the slider and/or the slide arm of the main drive in the relevant phase.

Preferred embodiments provide that the coupling device can be controlled by the output of the drive unit of the auxiliary drive.

It can preferably be provided that the drive unit of the auxiliary drive is arranged and/or supported on the slide rail of the main drive or a component fixed with the slide rail.

Particularly preferred embodiments provide that the coupling device is preferably formed to be engageable and disengageable in relation to the slider and/or slide arm of the main drive and/or preferably in relation to the output of the drive unit of the auxiliary drive during the closing process and/or during the opening process, preferably automatically controlled.

The coupling device, which is preferably arranged between the slide arm or the slider of the main drive and the output of the drive unit of the auxiliary drive, can be formed such that the coupling point, i.e. the joint, is arranged in the region of or adjacent to the slide arm or slider of the main drive or in the region of or adjacent to the output of the auxiliary drive.

Simple construction and high functional reliability result in particular if it is provided that the coupling device has a coupling element, which is formed movably supported on or in the slide rail of the main drive and/or a housing of the drive unit of the auxiliary drive and/or the output of the drive unit of the auxiliary drive and can be brought into and out of engagement with the slider and/or slide arm of the main drive in such a way that, in the engaged position of the coupling device, the coupling element is in engagement with the slider and/or slide arm of the main drive and in the disengaged position of the coupling device is out of engagement with the slider and/or slide arm of the main drive.

It is preferably provided that the coupling device has a coupling element, which can be controlled by the output of the drive unit of the auxiliary drive and is supported movably in a bearing, which is supported
a) on the slide rail of the main drive or a component fixed with the slide rail of the main drive, or
b) on the output of the auxiliary drive or a component fixed with the output of the auxiliary drive.

The bearing can preferably be formed as a pivot bearing and/or as a sliding bearing.

It can be provided in this case
that the coupling device, preferably the coupling element, has a catching recess, which can be brought into engagement and out of engagement with a carrier element arranged on the slide arm or on the slider, forming the engaged position of the coupling device when the catching recess is in engagement with the carrier element and forming the disengaged position of the coupling device when the catching recess is out of engagement with the carrier element; or
that the coupling device, preferably the coupling element, has a carrier element, which can be brought into engagement and out of engagement with a catching recess formed on the slide arm or on the slider, forming the engaged position of the coupling device when the catching recess is in engagement with the carrier element and forming the disengaged position of the coupling device when the catching recess is out of engagement with the carrier element.

In a preferred development, it can be provided that the coupling element is formed as a pivot lever, preferably as a coupling claw, namely preferably with a pivot bearing, which is formed fixedly with the slide rail of the main drive and/or the housing of the drive unit of the auxiliary drive and/or with the output of the drive unit of the auxiliary drive. Developments are particularly preferred which provide that the pivot lever is formed as a two-armed lever, one end of which interacts directly or indirectly with the output of the auxiliary drive and the other end of which interacts directly or indirectly with the slider and/or slide arm of the main drive.

In a preferred development it can be provided that the coupling element formed as a one-armed or two-armed pivot lever assumes a dead centre position in its disengaged position and/or in a closing position of the door in its engaged position under the action of the output of the drive unit of the auxiliary drive.

A particularly compact construction is possible with embodiments which provide that a connecting link is connected between the coupling element and the output of the drive unit of the auxiliary drive, one end of which link engages with the output in an articulated manner and the other end of which engages in an articulated manner on the pivotably supported coupling element.

A particularly high functionality is obtained if it is provided that the locking lever is arranged in its locking position in alignment with the connecting link, forming a dead centre position.

Preferred embodiments provide that the coupling element can be locked in its position disengaged from the slide arm and/or slider by a blocking device.

In preferred embodiments it can also be provided that the blocking device has a locking lever, which is supported pivotably in a bearing fixed with the slide rail of the main drive or with the drive unit of the auxiliary drive, wherein to form a locking position of the locking lever, the free end of the locking lever can be brought to stop against the output of the drive unit of the auxiliary drive or the free end can be brought to stop against the movably supported coupling element.

It can be provided that the locking lever (20aa) is arranged in its locking position in such a way that the connecting line between the pivot bearing of the locking lever and the output is aligned with the force direction of the output of the auxiliary drive.

It can be provided that the output of the auxiliary drive is guided in a guide device, wherein the guide device is formed fixed with the bearing of the drive unit of the auxiliary drive.

It can advantageously be provided that the coupling device has a control device, which is formed as a constituent of the coupling device or as a device separate from the coupling device, which device is drive-connected to the output of the auxiliary drive and/or the slide arm and/or slider of the main drive and acts on the coupling element to control the coupling element.

The control device can be formed e.g. by the guide device of the output of the auxiliary drive. The guide device can be formed in preferred embodiments as a slot in a guide housing or also as another guide, but preferably as a linear guide, e.g. as a guide hole, preferably in one or more transverse walls of the guide housing or as a guide sleeve or similar.

In preferred embodiments it can be provided that the control device is formed as a lever device supported pivotably on the output of the auxiliary drive or on the slide rail of the main drive or on a part fixed with the slide rail, one end of which lever device interacts with the slider and/or slide arm of the main drive and the other end of which interacts with the coupling element.

Embodiments which provide that a transmission device, formed preferably as a lever device and/or shift gate device, is connected between the coupling element and the output of the auxiliary drive to control the coupling element are particularly advantageous.

Embodiments which provide that a connecting link, which is guided in the guide device, is arranged between the output of the auxiliary drive and the coupling element are particularly advantageous.

It can be provided that the coupling element is supported in a pivot bearing, which is formed fixed with the guide device.

It can advantageously be provided that the coupling element is connected in an articulated manner to one end of the connecting link, the other end of which is supported pivotably and/or displaceably in the guide housing.

Alternatively or in addition, it can be provided that the coupling device has a coupling body controlling the coupling element, which body, acted upon by the output of the auxiliary drive, is guided movably in a guide device, which is fixed in terms of movement with the slide rail of the main drive and/or the drive unit of the auxiliary drive.

Particularly good functionality results with embodiments which provide that a shift gate device is connected between the coupling body and the coupling element, in that the coupling body has a shift gate slot and the coupling element has a shift gate pin or the coupling body has a shift gate pin and the coupling element has a shift gate slot. In a preferred further development, it can be provided that the guide device of the coupling body has a shift gate slot, in which the shift gate pin engages, or that the guide device of the coupling body has a shift gate pin, which engages in the shift gate slot of the coupling body and/or of the coupling element.

Preferred embodiments can provide that the output of the auxiliary drive is formed as a linear output. In a preferred further development it can be provided that the linear output is formed as a piston rod.

In preferred embodiments it can be provided that the piston rod forms a toggle lever configuration with the coupling element supported in an articulated manner in the engaged and/or disengaged position of the coupling element.

Preferred embodiments can provide that the drive unit of the auxiliary drive is formed as a gas pressure spring.

Preferred embodiments can provide that the drive unit of the auxiliary drive is supported in a fixed bearing fixed with the slide rail of the main drive or in a pivot bearing fixed with the slide rail of the main drive.

Particular compactness of the construction results with embodiments which provide that the drive unit of the auxiliary drive is arranged inside or on the outside of the slide rail of the main drive and/or a housing of the auxiliary drive fixed with the slide rail and/or inside a common housing and/or a common cover of the components of the main drive and of the auxiliary drive to be mounted on the frame side.

The invention is explained in greater detail below with reference to figures. There are shown in:

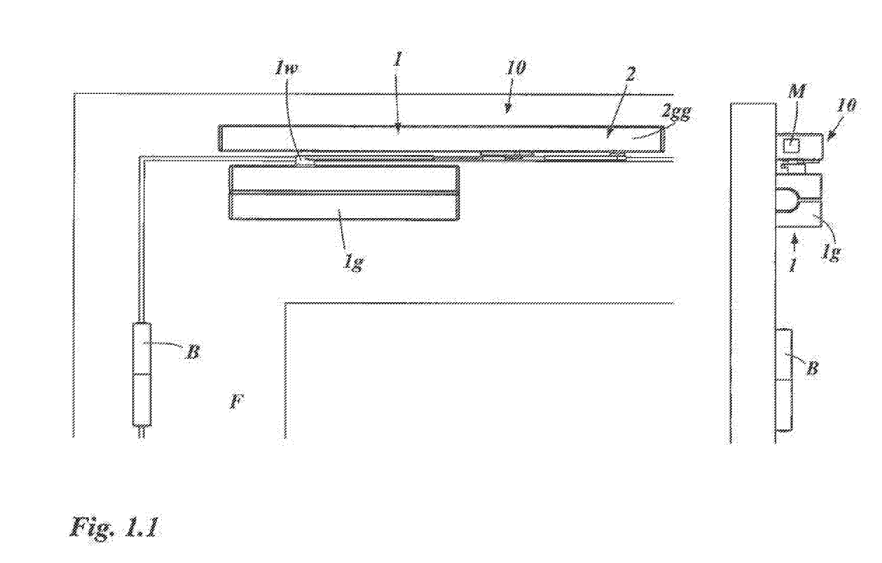

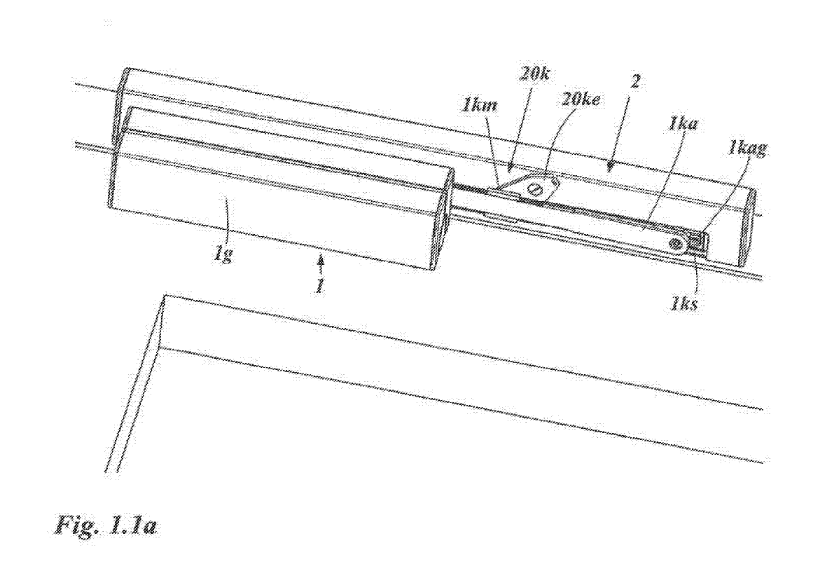

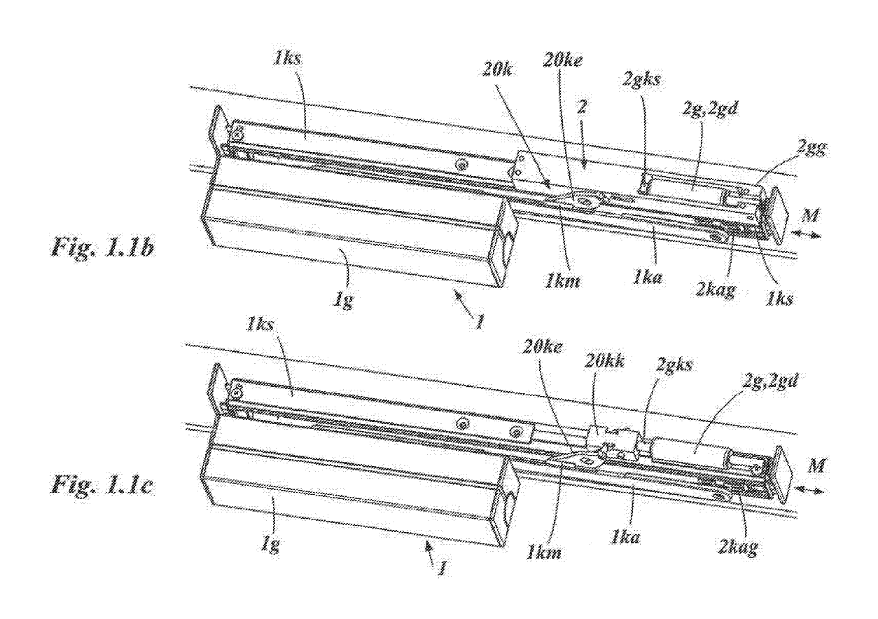

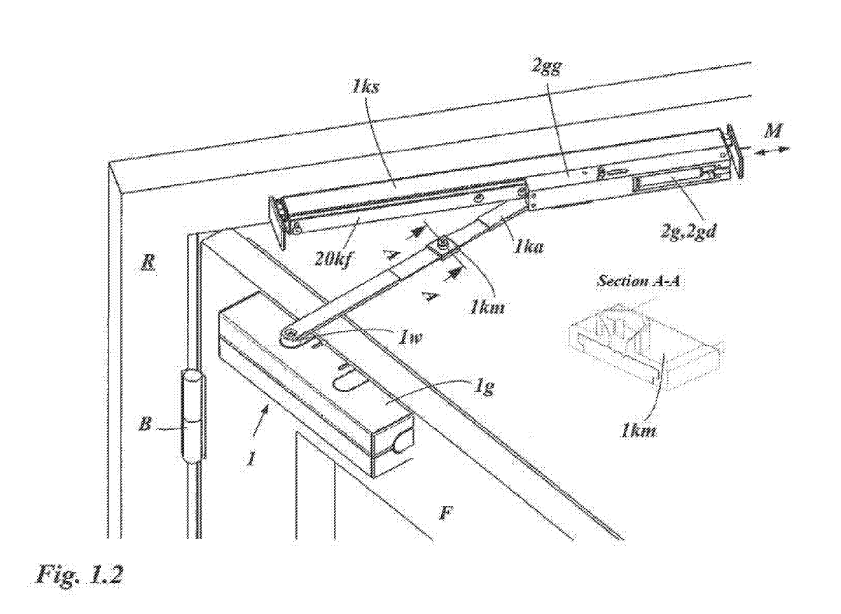

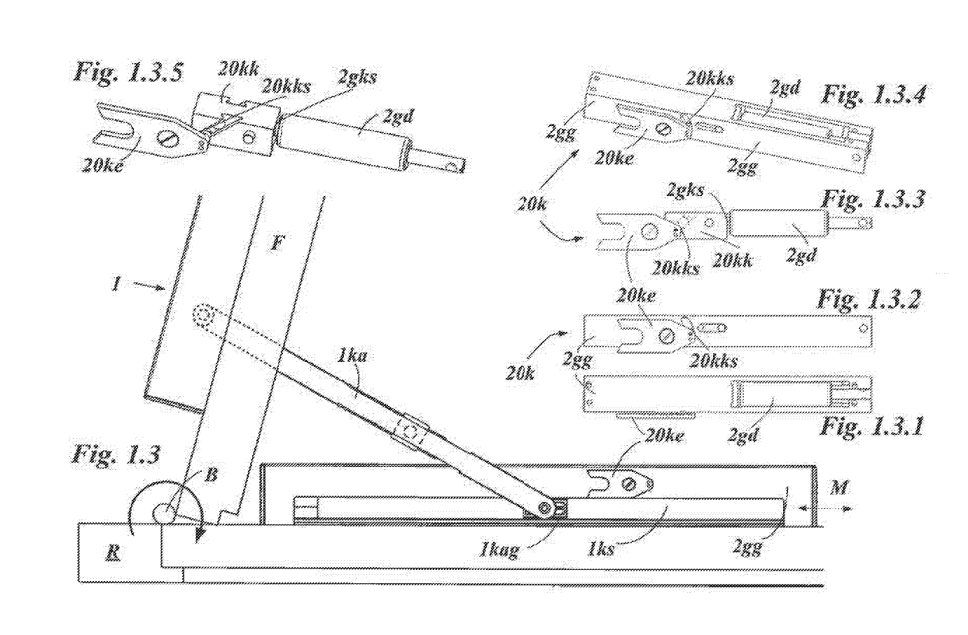

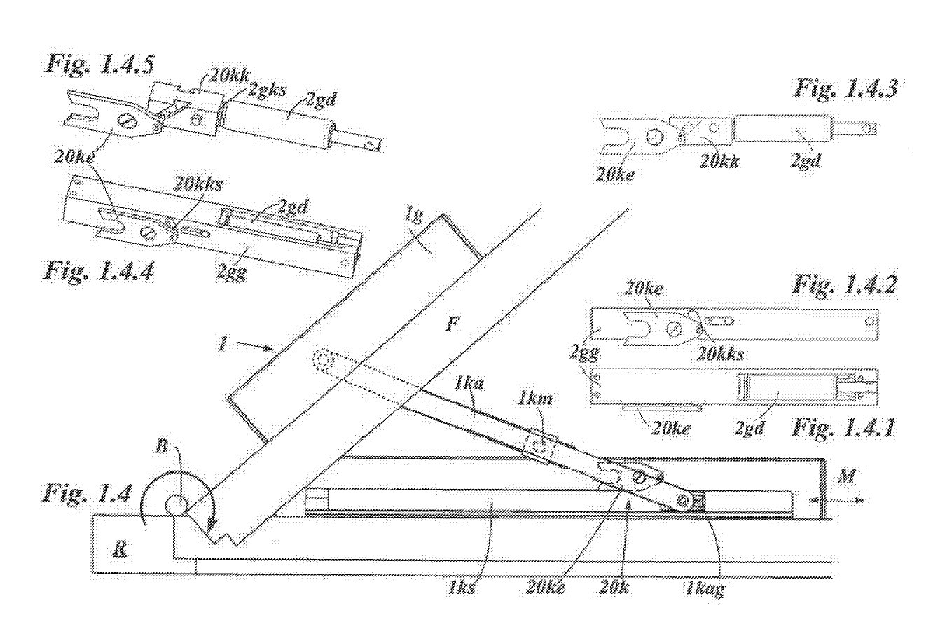

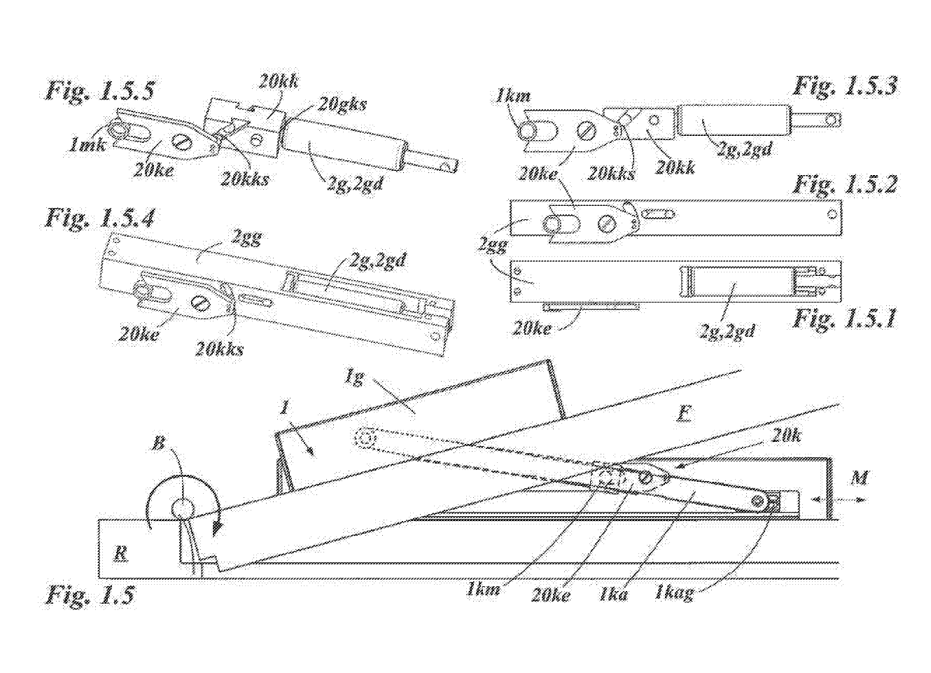

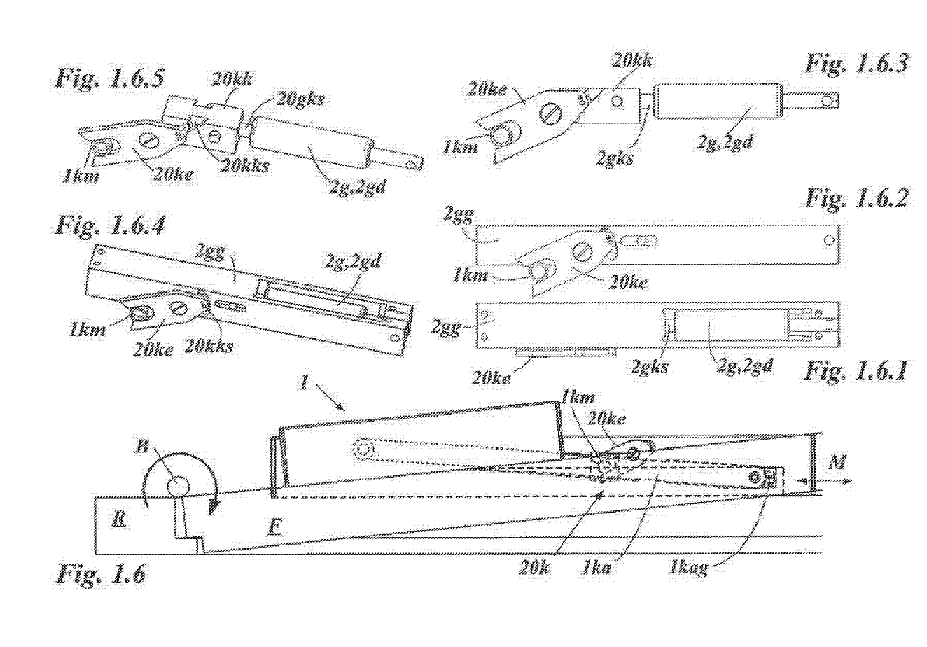

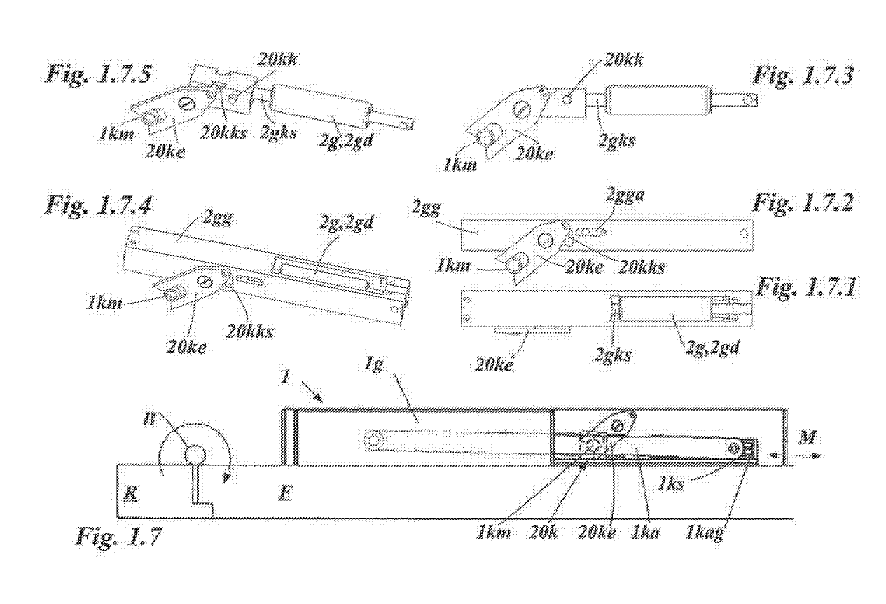

FIG. 1.1 a front view of a door with a first embodiment example of a door drive according to the invention, the door in closed position;

FIG. 1.1a a perspective representation of the embodiment example in FIG. 1.1, but in a viewing direction obliquely from below;

FIG. 1.1b a representation of the embodiment example as in FIG. 1.1a, but without the covering panel on the frame side;

FIG. 1.1c a representation of the embodiment example as in FIG. 1.1b, but also without the housing of the auxiliary drive on the frame side and the coupling device;

FIG. 1.2 a representation of the embodiment example as in FIG. 1.1b, but in a viewing direction obliquely from above and the door in an open position;

FIG. 1.3 a representation of the embodiment example as in FIG. 1.1a, but in a viewing direction obliquely from below and the door in an open position as in FIG. 1.2;

FIG. 1.3.1 a front view of FIG. 1.3, but without the frame-side covering panel and as a section showing the auxiliary drive with coupling device;

FIG. 1.3.2 a plan view of FIG. 1.3.1, but in a viewing direction from below;

FIG. 1.3.3 a representation as in FIG. 1.3.2, but without the auxiliary drive housing and the coupling device;

FIG. 1.3.4 a perspective representation of FIG. 1.3.1, but in a viewing direction obliquely from below;

FIG. 1.3.5 a perspective view of FIG. 1.3.3, but in a viewing direction obliquely from above;

FIG. 1.4 a representation of the embodiment example corresponding to FIG. 1.3, but with the door in an open position with a smaller door opening angle;

FIG. 1.4.1 a front view of FIG. 1.4, but without the frame-side covering panel and as a section showing the auxiliary drive with coupling device;

FIG. 1.4.2 a plan view of FIG. 1.4.1, but in a viewing direction from below;

FIG. 1.4.3 a representation as in FIG. 1.4.2, but without the housing of the auxiliary drive and the coupling device;

FIG. 1.4.4 a perspective representation of FIG. 1.4.1, but in a viewing direction obliquely from below;

FIG. 1.4.5 a perspective view of FIG. 1.4.3, but in a viewing direction obliquely from above;

FIG. 1.5 a representation of the embodiment example corresponding to FIG. 1.4, but with the door in an open position with an even smaller door opening angle;

FIG. 1.5.1 a front view of FIG. 1.5, but without the frame-side covering panel and as a section showing the auxiliary drive with coupling device;

FIG. 1.5.2 a plan view of FIG. 1.5.1, but in a viewing direction from below;

FIG. 1.5.3 a representation as in FIG. 1.5.2, but without the housing of the auxiliary drive and the coupling device;

FIG. 1.5.4 a perspective representation of FIG. 1.5.1, but in a viewing direction obliquely from below;

FIG. 1.5.5 a perspective view of FIG. 1.5.3, but in a viewing direction obliquely from above;

FIG. 1.6 a representation of the embodiment example corresponding to FIG. 1.5, but with the door in an open position with an even smaller door opening angle, i.e. close to the closed position;

FIG. 1.6.1 a front view of FIG. 1.6, but without the frame-side covering panel and as a section showing the auxiliary drive with coupling device;

FIG. 1.6.2 a plan view of FIG. 1.6.1, but in a viewing direction from below;

FIG. 1.6.3 a representation as in FIG. 1.6.2, but without the housing of the auxiliary drive and the coupling device;

FIG. 1.6.4 a perspective representation of FIG. 1.6.1, but in a viewing direction obliquely from below;

FIG. 1.6.5 a perspective view of FIG. 1.6.3, but in a viewing direction obliquely from above;

FIG. 1.7 a representation of the embodiment example corresponding to FIG. 1.6, but with the door in the closed position;

FIG. 1.7.1 a front view of FIG. 1.7, but without the frame-side covering panel and as a section showing the auxiliary drive with coupling device;

FIG. 1.7.2 a plan view of FIG. 1.7.1, but in a viewing direction from below;

FIG. 1.7.3 a representation as in FIG. 1.7.2, but without the housing of the auxiliary drive and the coupling device;

FIG. 1.7.4 a perspective representation of FIG. 1.7.1, but in a viewing direction obliquely from below;

FIG. 1.7.5 a perspective view of FIG. 1.7.3, but in a viewing direction obliquely from above;

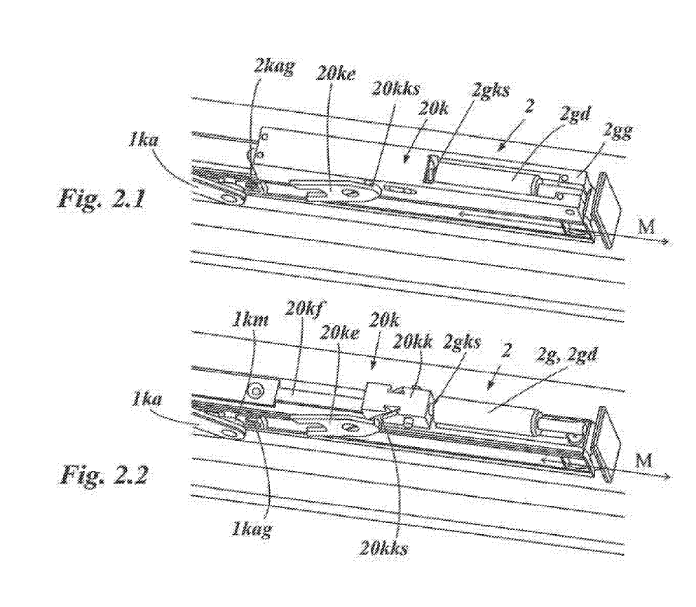

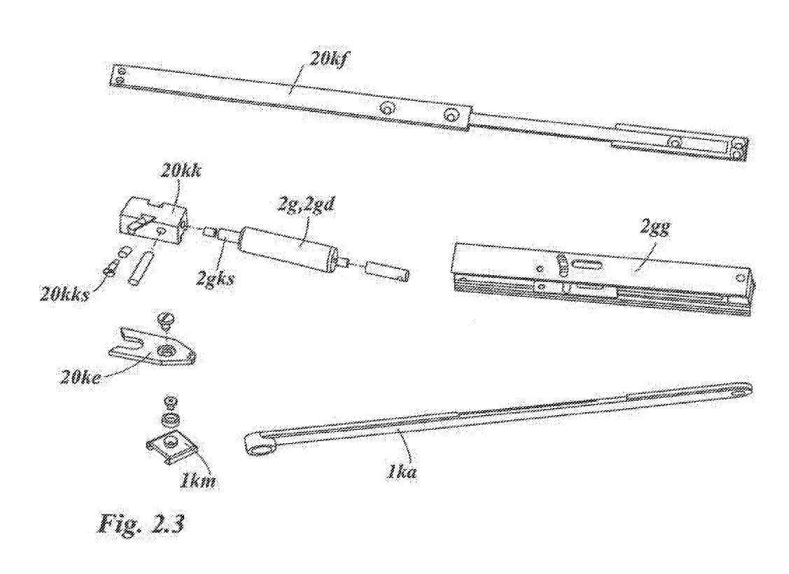

FIG. 2.1 a perspective view of a door with a second embodiment example of a door drive according to the invention, section showing the auxiliary drive with coupling device without frame-side covering panel, the door in an open position;

FIG. 2.2 a representation of the embodiment example corresponding to FIG. 2.1, but without the housing of the auxiliary drive and the coupling device;

FIG. 2.3 an exploded representation of the auxiliary drive with coupling device of FIGS. 2.1 and 2.2;

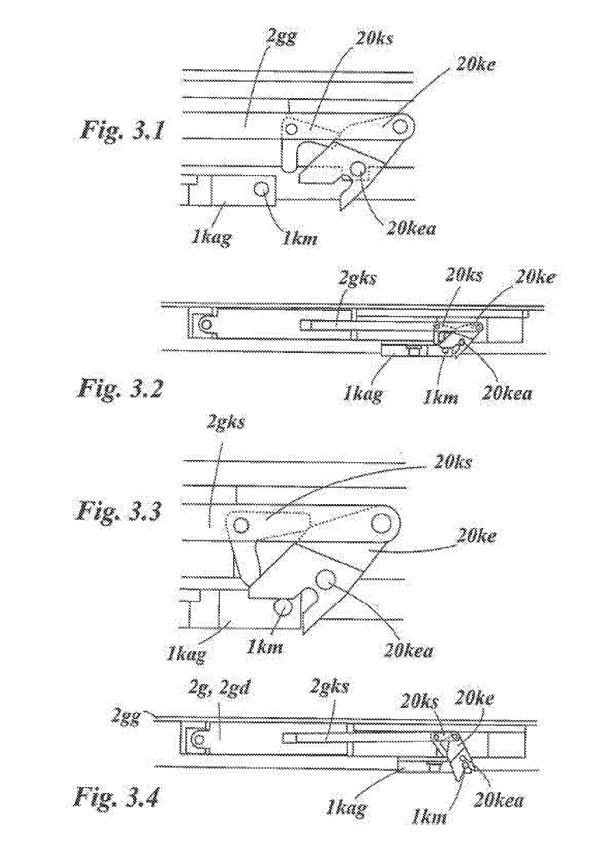

FIG. 3.1 a schematic sectional view of a door with a third embodiment example of a door drive according to the invention, as a section showing the coupling device, the door in an open position;

FIG. 3.2 a representation corresponding to FIG. 3.1, but showing the entire auxiliary drive and the door in an open position with a smaller door opening angle, i.e. already close to the closed position;

FIG. 3.3 a representation corresponding to FIG. 3.1 of the coupling device, the door immediately before the closed position;

FIG. 3.4 a representation corresponding to FIG. 3.2, but with the door in the closed position;

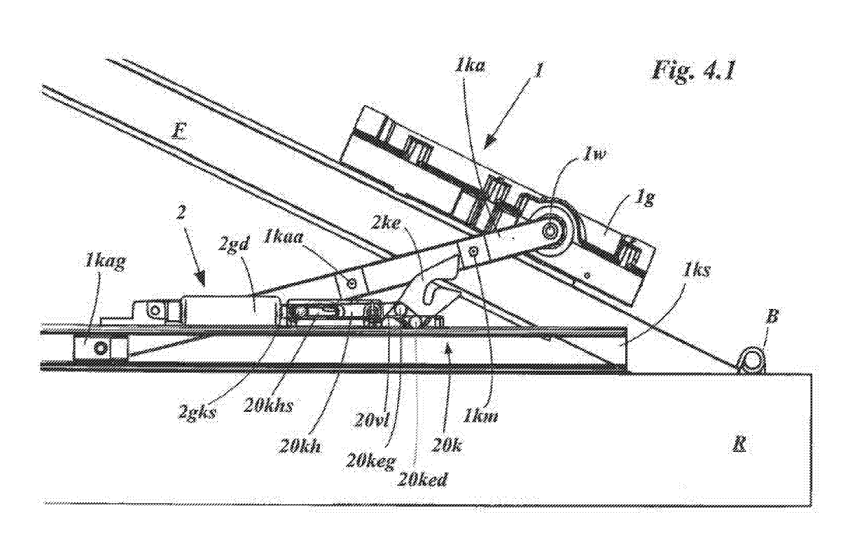

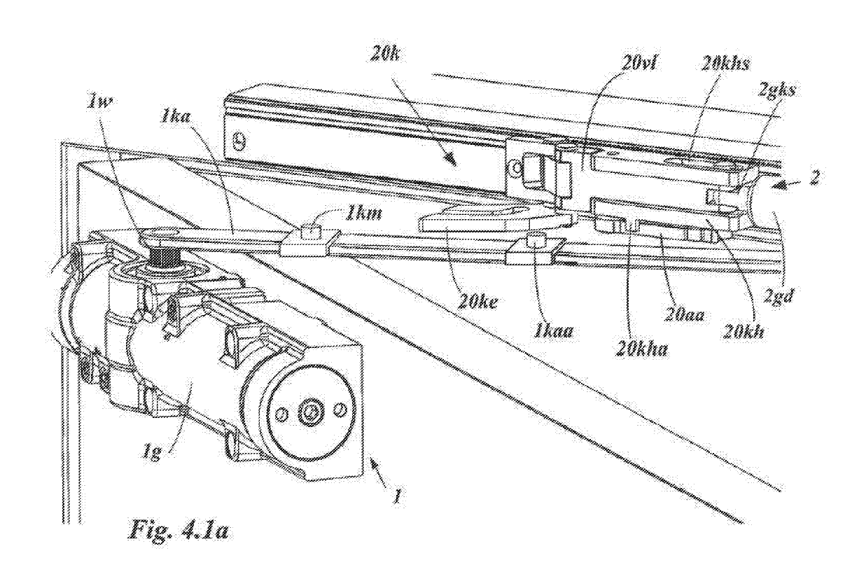

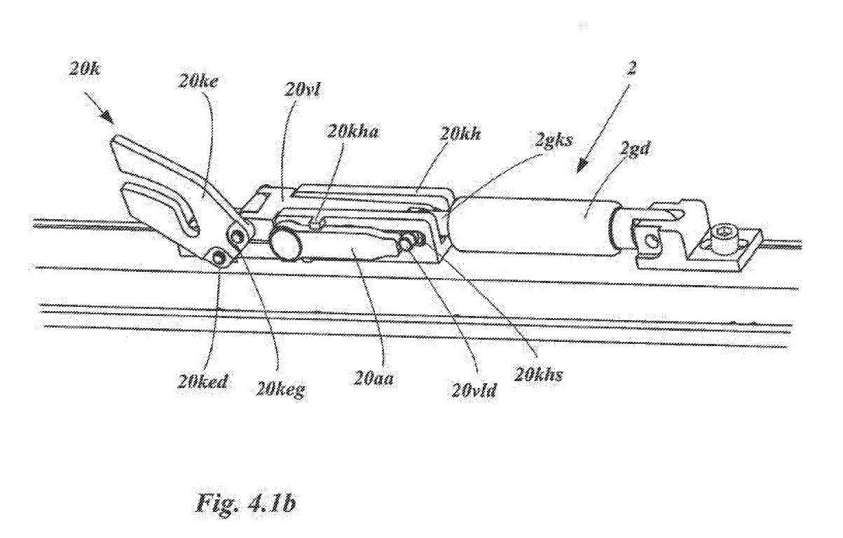

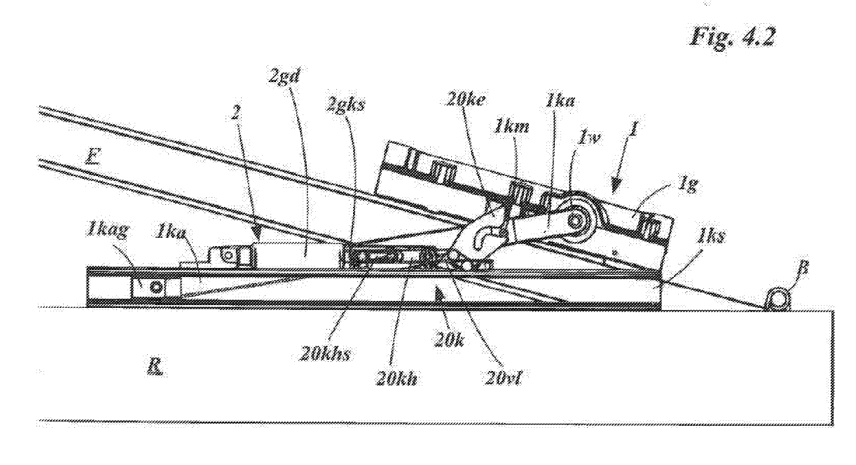

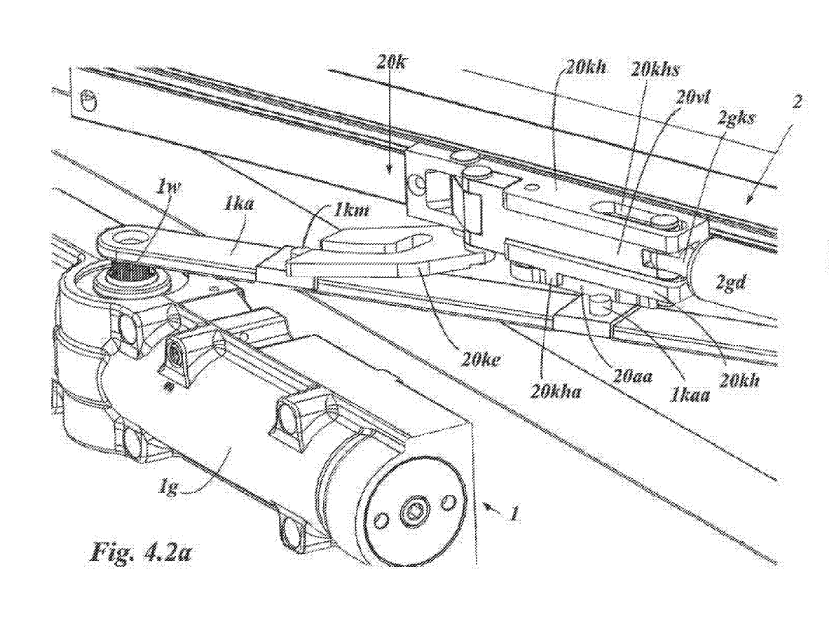

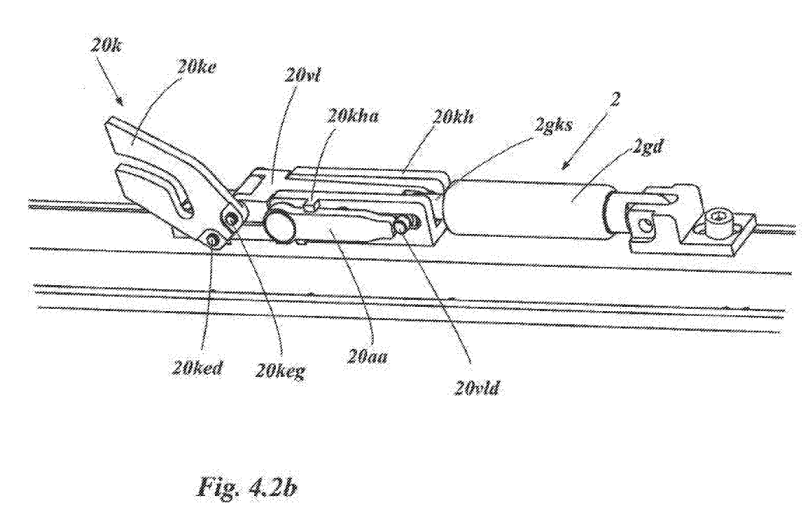

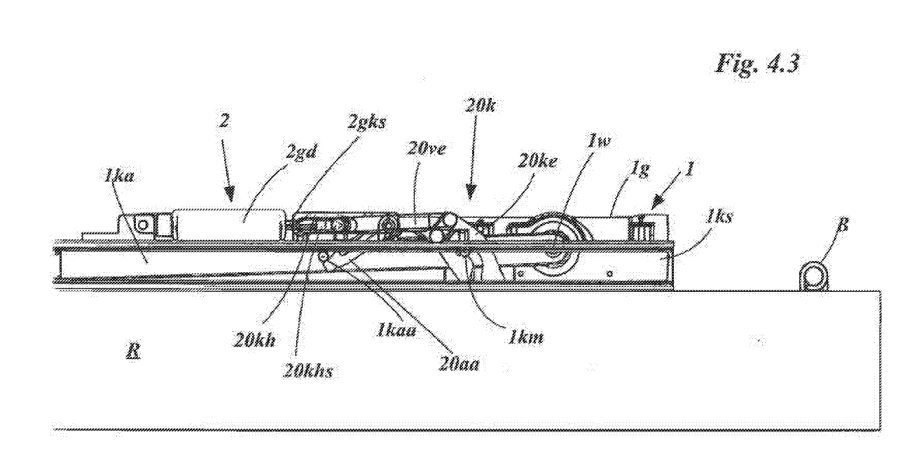

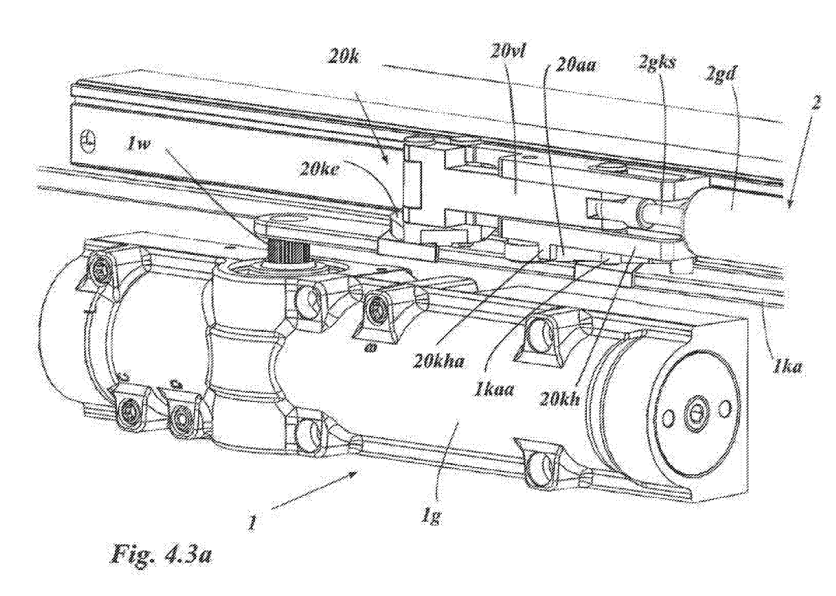

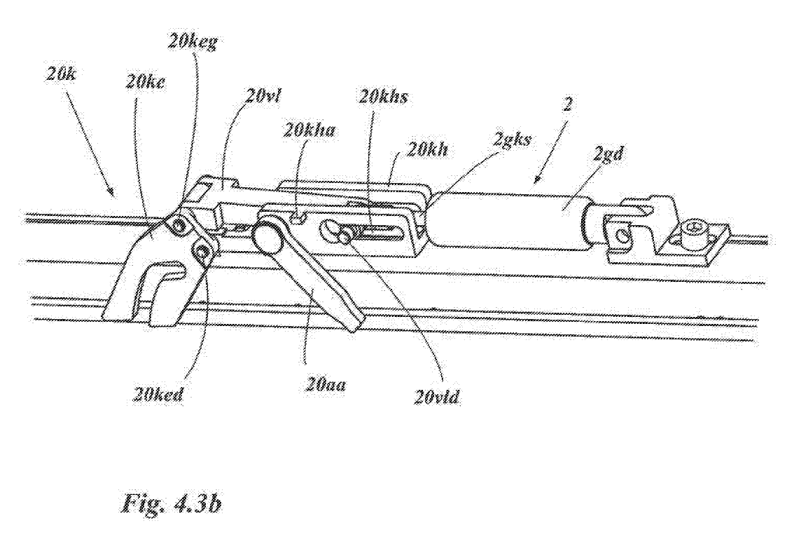

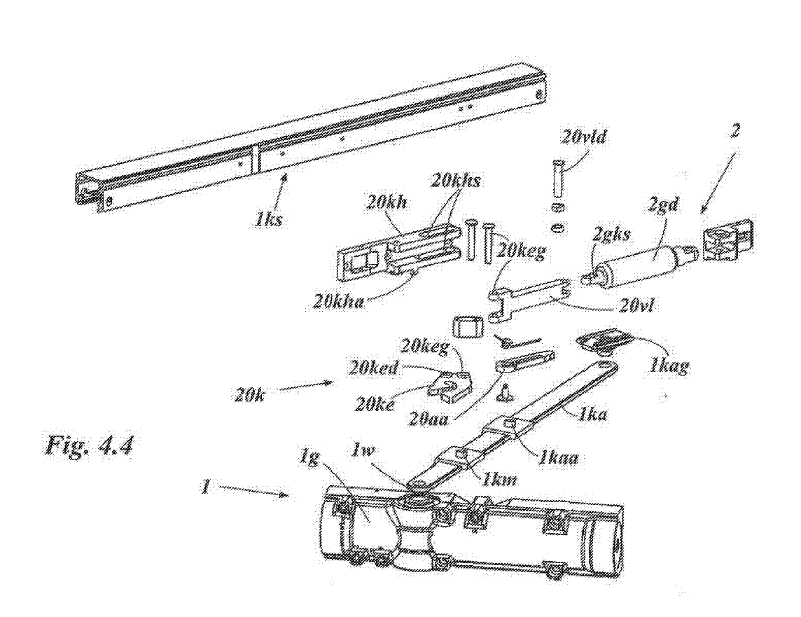

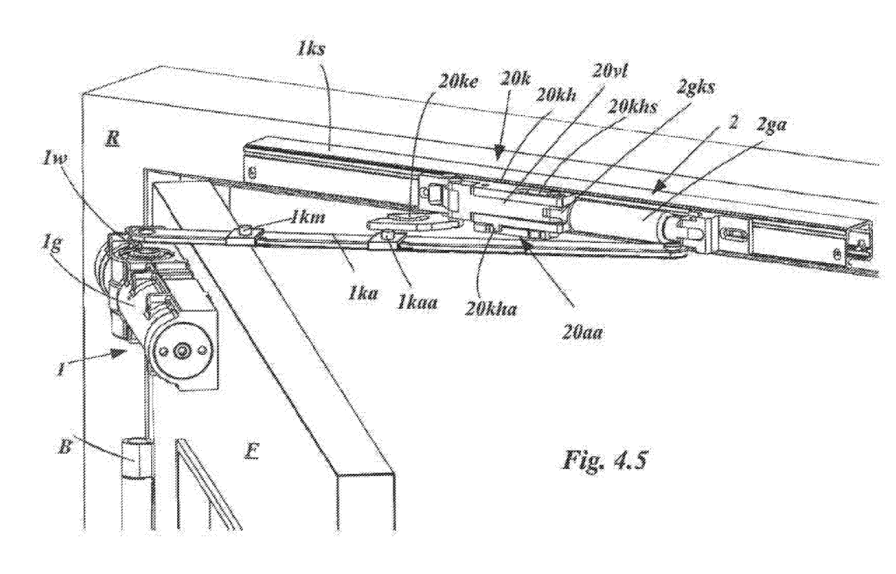

FIG. 4.1 a plan view of a door with a further embodiment example of a door drive according to the invention, the door in an open position, the coupling device disengaged, viewing direction from above;

FIG. 4.1a an enlarged section in the area of the coupling device in FIG. 4.1, perspective view, viewing direction onto the front side of the door frame;

FIG. 4.1b a bottom view of the coupling device in FIG. 4.1a, perspective view, viewing direction obliquely from below;

FIG. 4.2 a representation of the embodiment example corresponding to FIG. 4.1, but with the door in an open position with a smaller door opening angle at the start of the engagement process;

FIG. 4.2a an enlarged section in the area of the coupling device in FIG. 4.2, perspective view, viewing direction onto the front side of the door frame;

FIG. 4.2b a bottom view of the coupling device in FIG. 4.2a, perspective view, viewing direction obliquely from below;

FIG. 4.3 a representation of the embodiment example corresponding to FIG. 4.2, but with the door in closed position, the coupling device engaged;

FIG. 4.3a an enlarged section in the area of the coupling device in FIG. 4.3, perspective view, viewing direction onto the front side of the door frame;

FIG. 4.3b a bottom view of the coupling device in FIG. 4.3a, perspective view, viewing direction obliquely from below;

FIG. 4.4 an exploded representation of the door drive of FIGS. 4.1 to 4.3;

FIG. 4.5 a perspective view of the door drive of FIGS. 4.1 to 4.4, showing the components in the mounted position on the door, namely with the position of the components as in the open position of the door shortly before the engagement or disengagement of the coupling device with the carrier.

The first embodiment example shown in FIGS. 1.1 to 1.7 is a door drive 10 mounted on a door. The door has a door panel F, which is supported pivotably about a vertical axis of rotation in door hinges B in a fixed door frame R.

The door drive 10 is composed of a main drive 1 and an auxiliary drive 2.

The main drive 1 is formed in the specific case as a door closer, namely as a slide arm door closer. It comprises a door closer unit with a door closer housing 1g, which is mounted on the door panel F. In the door closer housing 1g is a door closer mechanism with closer spring and a damping device, preferably formed as a hydraulic piston-cylinder device. This door closer device in the door closer housing 1g forms the drive unit of the main drive. The output of this drive unit is formed by a door closer shaft 1w supported rotatably in the door closer housing. As can be seen e.g. in FIG. 1.2, a power-transmitting linkage, which is formed as a slide arm 1ka and a slide rail 1ks, is connected to the door closer shaft 1w. As can be seen e.g. in FIG. 1.3, the slide arm 1ka is guided in the slide rail 1ks with a slider 1kag arranged at its free end. The slide rail 1ks is mounted on the fixed door frame R. The slide arm 1ka with the slide rail 1ks forms the power transmission device of the main drive 1.

As can best be seen in FIGS. 1.1a, 1.1b and 1.1c, the auxiliary drive 2 including its coupling device 20k is mounted on the front side of the slide rail 1ks of the main drive 1. The auxiliary drive 2 interacts in the embodiment example shown via the coupling device 20k with the slide arm 1ka of the main drive 1, as described in greater detail below. As FIG. 1.1a shows, all the frame-side components of the main drive 1 and of the auxiliary drive 2 including the coupling device 20k are covered by a common covering panel. In FIGS. 1.1b and 1.1c this covering panel has been removed. In FIG. 1.1c the housing 2gg is also removed additionally. The housing 2gg forms the bearing housing of the drive unit 2g of the auxiliary drive 2 and in addition the bearing and guide housing of the coupling device 20k.

The auxiliary drive 2 has a drive unit 2g, which in the embodiment example shown is formed as a gas pressure spring 2gd with a piston rod 2gks. The piston rod 2gks forms the output of the drive unit 2g of the auxiliary drive 2. The named coupling device 20k is connected between this output of the auxiliary drive 2 and the slide arm 1ka of the main drive. During the closing process and during the opening process it automatically couples and uncouples the drive unit 2g of the auxiliary drive 2 and the slide arm 1ka of the main drive 1 when the door reaches a predetermined opening angle, with the result that, during the closing process and during the opening process, the auxiliary drive is engaged in a door angle range between the closed position and a predetermined opening angle, namely between the closed position and a 10° door opening angle in the embodiment example shown. As long as the auxiliary drive 2 is engaged, it supports the main drive 1 in that it additionally drives the slide arm 1ka of the main drive, i.e. additionally to the drive mechanism of the drive unit 1g of the main drive 1. In the specific case shown, the auxiliary drive 2 is formed as a closer drive. The drive unit 2g comprises a gas pressure spring as energy store, which is charged during the opening process and discharged during the closing process. As well as the energy store, a damping device is included with which the opening and closing speed can be influenced, and can preferably be variably adjusted. The energy store is charged during the opening process, in the phase of the opening movement in which the auxiliary drive 2 is engaged, and discharged during the closing process in the phase in which the auxiliary drive is engaged. In the disengaged position, the energy store is locked, i.e. it is neither charged nor discharged, it remains in the charging state.

As can best be seen in FIGS. 1.3.1 to 1.3.5, FIGS. 1.4.1 to 1.4.5, FIGS. 1.5.1 to 1.5.5, FIGS. 1.6.1 to 1.6.5 and FIGS. 1.7.1 to 1.7.5, the coupling device 20k comprises a coupling body 20kk, driven by the piston rod, with shift gate slot and a coupling lever 20ke, which is supported pivotably in a fixed pivot bearing in the housing 2gg and has a shift gate pin 20kks, which is guided in the shift gate slot of the coupling body 20kk. The coupling body 20kk is connected fixedly in terms of movement to the output end of the piston rod 2gks and is slot-guided in the housing 2gg. In the specific case, there is a guide slot for this in the housing 2gg, in which slot a pin fixed in the coupling body 20kk is guided.

In addition, another guide rail device 20kf is arranged in the housing 2gg, on which device the coupling body 20kk is guided longitudinally (see FIG. 1.2).

During the movement of the piston rod 2gks, the coupling body 20kk is moved guided in this way in the housing 2gg. The coupling lever 20ke, which is guided via the shift gate pin 20kks in the shift gate slot of the coupling body 20kk, is forcibly moved. The coupling lever 20ke is formed as a coupling claw and at its free end has a catching recess, with which it interacts with a carrier 1km arranged on the slide arm 1ka. In the engaged position, the carrier 1km is in engagement in the catching recess of the coupling lever 20ke. In the disengaged position, the carrier 1km is outside the engaged position. In FIGS. 1.5 to 1.7 it is shown how, during the closing process, the coupling lever 20ke comes into engagement with the carrier 1km in the vicinity of the closed position of the door. Due to continuing movement of the coupling body 20kk, the coupling lever 20ke is driven by the piston rod 20gks on the output side, i.e. pivoted under forced control. Via the engagement of the coupling lever 20ke with the carrier 1km, the auxiliary drive 2 acts on the slide arm 1ka of the main drive 1 and in this way supports the main drive 1 in the engaged phase of the closing process under the action of the gas pressure spring 2gd, which is discharging in the process. In the engaged phase of the opening process, the gas pressure spring 2gd is charged.

The second embodiment example, shown in FIGS. 2.1 to 2.3, is a modified embodiment compared with the embodiment example of FIGS. 1.1 to 1.7. The modification consists only in that the coupling device 20k with the coupling lever 20ke interacts directly with the slider 1kag of the slide arm 1ka of the main drive 1 and not directly with the slide arm 1ka. However, directly means with the interconnection of the carrier 1km fixed on the slider 1kag or on the slide arm 1ka. In the case of the embodiment example of FIGS. 2.1 to 2.3, the carrier 1km is arranged in or on the slider 1kag and the coupling lever 20ke interacts with this. In the engaged position, the carrier 1km is in engagement with the catching recess of the coupling lever 20ke and in the disengaged position it is out of this engagement. The mode of operation is otherwise the same as for the embodiment example of FIGS. 1.1 to 1.7.

For the opposite hinge side mounting, however, the embodiment example of FIGS. 1.1 to 1.7 results in advantages compared with the embodiment example of FIGS. 2.1 to 2.3. The reason for this is as follows: as is known, in the case of opposite hinge side mounting, the slider 1kag runs in the slide rail 1ks in the case of a small door opening angle with a direction reversal, whereas the direction of rotation of the slide arm 1ka remains the same over the entire closing process as also over the entire opening process, i.e. no reversal of rotation direction of the slide arm takes place. The embodiment of FIGS. 1.1 to 1.7, in which the coupling device engages not on the slider 2kag, but on the slide arm 2ka, can therefore be used in the case of opposite hinge mounting in the same way as in the case of normal hinge-side mounting, namely without any modification of the device having to be carried out.

The third embodiment example, shown in FIGS. 3.1 to 3.4, is a modified embodiment compared with FIGS. 2.1 to 2.2. The modification consists in that the coupling device 20k is designed differently. In the embodiment example of FIGS. 3.1 to 3.3 the coupling device 20k has a coupling lever 20ke, which is likewise formed in the manner of a claw with a catching recess and is articulated on the piston rod 20gks of the auxiliary drive 2. In addition, however, the coupling lever 20ke is supported pivotably in its central section in the same way as in the embodiment example of FIGS. 2.1 to 2.3 in a pivot bearing 20kea that is fixed with the housing 2gg of the drive unit 2g of the auxiliary drive 2 and with the slide rail 2ks of the main drive 1 and interacts with its free end with the catching recess in principle in the same manner with a carrier 1km, which is arranged in the slider 1kag of the main drive 1, as explained in the case of the embodiment example of FIGS. 2.1 to 2.3. The housing 2gg takes up the drive unit 2g of the auxiliary drive 2 including the piston rod 2gks and the coupling device 20k. In the embodiment example of FIGS. 3.1 to 3.4, the carrier 1km is formed as a carrier pin 1km, which is arranged in the slider 1kag in the horizontal movement plane of the slide arm 2ka but transverse to the movement direction of the slider 1kag.

To control the coupling lever 2ke, however, a control lever 20ks is provided in the embodiment of FIGS. 3.1 to 3.4 instead of the coupling body 20kk. The control lever 20ks is formed in the case represented as a two-armed lever, the two lever arms of which form an apex angle of approximately 90°. The control lever 20ks is supported pivotably in its apex area in a pivot bearing fixed in the slide rail 1ks and/or in the housing 2gg. The end of one lever arm interacts with a control cam on the facing edge of the coupling lever 20ke. The free end of the other lever arm of the control lever 20ks interacts with a stop edge on the slider 1kag, in that the free end of this lever arm comes into a stop position with the stop edge formed on the slider 1kag during the closing process at a predetermined small door opening angle. At the same time, the coupling lever 20ke comes into engagement with its catching recess with the carrier 1km. Because of the drive connection with the piston rod 2gks of the auxiliary drive 2, the control lever 20ks, which is stopped on the stop edge of the slider 1kag, is rotated counter-clockwise in the representation in the figures. The lever arm associated with the coupling lever 20ke stops with its free end against the control cam of the coupling lever 20ke and upon its rotation it forcibly also rotates the coupling lever 20ke counter-clockwise. The slider 1kag of the slide arm 1ka of the main drive 1, which is in engagement with the coupling lever 20ke via the carrier 1km, is thereby carried along in the closing direction.

FIG. 3.1 shows the situation in the closing process before the coupling engagement takes place, i.e. with a correspondingly large door opening angle.

FIG. 3.2 shows the engagement as soon as the door panel F has reached the predetermined small door opening angle.

FIG. 3.3 shows the start of the rotary movement of the two levers, i.e. the rotary movement of the control lever 20ks due to the stop position with the slider 1kag and the carrying along of the coupling lever 20ke by the control lever 20ks acting on the coupling lever 20ke in that the lever arm of the control lever 20ks associated with the control cam of the coupling lever 20ke acts on the control cam and rotates the coupling lever 20ke counter-clockwise.

In FIG. 3.4 the closed position is shown. Both levers 20ks and 20ke are rotated into their end position counter-clockwise. The control lever 20ks still lies against the stop edge of the slider and the coupling lever 20ke is still in engagement with the carrier 1km of the slider 1kag.

The embodiment example in FIGS. 4.1 to 4.5 (called FIG. 4 for short below) is a modification of the embodiment example in FIGS. 1.1 to 1.7 (called FIG. 1 for short below). The embodiment example of FIG. 4 differs from the embodiment example of FIG. 1. As regards the design of the components and their association, reference is first made primarily to FIGS. 4.4 and 4.5. In the embodiment example in FIG. 4, in contrast to the embodiment examples of the figures described previously, the gas pressure spring 2gd is not arranged pivotably on the slide rail 1ks of the main drive, but in a fixed bearing arranged on the slide rail 1ks. This means that the gas pressure spring 2gd is fixedly supported with its housing on the slide rail 1ks. The piston rod 2gks is guided displaceably in a guide housing 20kh fixed with the slide rail 1ks linearly in the extension direction of the slide rail 1ks. Connected between the free end of the piston rod 2gks and the coupling lever 20ke is a connecting link 20vl which, during the retraction and extension of the piston rod 2gks, controls the pivot movement of the coupling lever 20ke. The connecting link 20vl is connected for this purpose by one end to the end of the piston rod 2gks and by its other end to the coupling lever 20ke via a pivoting bearing in each case.

The coupling lever 20ke is supported in a pivot bearing 20ked fixed with the slide rail 1ks and is controlled in the embodiment example in FIG. 4 by the connecting link 20vl controlled by the piston rod 2gks. The connecting link 20vl is connected to the coupling lever 20ke via a pivoting bearing 20keg. The guiding of the connecting link 20vl is formed in such a way that the swivel joint 20vld, with which the connecting link 20vl is connected to the end of the piston rod 2gks, is guided in a guide slot 20khs in the guide housing 20kh. For this purpose, the swivel joint has a bearing pin 20vld, which is guided in the guide slot 20khs as a guide pin, wherein the bearing pin 20vld can have a guide role.

In the embodiment example shown in FIG. 4, the guide slot 20khs is formed linearly in the extension direction of the guide housing 20kh, i.e. also parallel to the extension direction of the slide rail 1ks.

Determination of the angular position of the coupling lever 20ke in its position disengaged from the carrier 1km, i.e. when the coupling lever 20ke is disengaged from the carrier 1km arranged on the slide arm in the door opening angle range greater than approx. 15° (see FIGS. 4.1 and 4.5), is carried out in the embodiment example in FIG. 4 by a locking arm 20aa. Reference is made below to FIGS. 4.1, 4.1a, 4.1b and 4.2, 4.2a, 4.2b and 4.3, 4.3a, 4.3b. The locking arm 20aa is supported pivotably on the guide housing 20kh and, in the disengaged position of the coupling lever 20ke, is in its locking position (see FIG. 4.5 as well as FIGS. 4.1, 4.1a, 4.1b and 4.2, 4.2a, 4.2b). In the locking position the locking lever 20aa is aligned with the longitudinal extension of the guide housing 20kh and the guide slot 20khs. The free end of the locking arm 20aa is in engagement in this position with the free end of the piston rod 20gks, i.e. with the guide pin arranged on the free end of the piston rod, which pin is guided in the guide slot 20khs in the housing 20kh. The guide pin is formed by the bearing pin 20vld of the connecting link 20vl. In this locking position of the locking arm 20aa, the locking arm 20aa is also aligned with the movement direction and power transmission direction of the piston rod 20gks, with the result that in this position a dead centre position is obtained, in which the piston rod 2gks holds the coupling lever 20ke stopped in its disengaged angular position via the locking arm 20aa and thus a dead centre position is realised. This disengaged angular position of the coupling lever 20ke is shown in FIGS. 4.1 and 4.2.

The dead centre position is automatically cancelled when the door reaches the predetermined door opening angle in the closing direction during closing, in the case shown a door opening angle of approx. 15° (see FIGS. 4.2, 4.2a and 4.2b). In this door opening angle the locking arm 20aa comes into the stop position against a control pin 1kaa, which is arranged on the slide arm 1ka of the main drive 1 and during further closing is carried along by the control pin 1kaa, i.e. rotated counter-clockwise in the representations in FIGS. 4.1, 4.2 and 4.3. The locking position of the locking arm 20aa is thus cancelled, i.e. the free end of the locking arm 20aa disengages from the guide pin 20vld at the free end of the piston rod 20gks. At the free end of the locking arm 20aa a locking recess is formed, in which the guide pin 20vld arranged at the free end of the piston rod 20gks engages in the locking position. The piston rod 20gks is initially retracted a little while the locking arm 20aa is being pressed out of engagement. This retraction can take place automatically due to the coupling lever 20ke coming into engagement with carrier 1km because of the rotation of the coupling lever 20ke. Another release mechanism is also possible, however. As soon as the engagement of the locking arm 20aa is cancelled, however, an extension of the piston rod 2gks takes place under the action of the gas pressure spring 2gd. During this extension of the piston rod, the connecting link 20vl is moved. The guide pin 20vld arranged at the end of the connecting link 20vl runs in the guide slot 20khs. With its end articulated to the coupling lever 20ke, the connecting link 20vl carries out a pivot movement out of the guide housing 20kh and thereby pivots the coupling lever 20ke, which in this door opening range engages with the carrier 1km because of the geometrical arrangement.

The coupling lever 20ke is formed identical to the embodiment examples in FIGS. 1 to 3 as a coupling claw with a catching recess. The pivot movement of the coupling lever 20ke, driven by the gas pressure spring 2gd, acts on the carrier 1km in such a way that the further closing process takes place in the manner of closing retardation and simultaneous closing of the door under the action of the gas pressure spring 2gd as auxiliary drive. FIG. 4.3 shows the closed position of the door. The locking lever 20aa is pivoted out, i.e. not in the locking position. The locking lever 20aa is held in this pivoted-out position under the action of the control pin 1kaa arranged on the slide arm 1ka.

During the opening process, a reverse action of the gas pressure spring as auxiliary drive takes place compared with the closing process. During the opening process, the gas pressure spring is charged as long as the coupling lever 20ke is engaged with the carrier 1km. Opening damping is thereby achieved. The locking arm 20aa is reset by a reset spring into its orientation aligned with the guide housing 20kh, while the door is opened. During the opening process the coupling lever 20ke is pivoted back under the action of the carrier 1km as long as it is coupled to the carrier 1km. The connecting link 20vl is pivoted inwards back into the guide housing 20kh with retraction of the piston rod 2gks. As soon as the predetermined door opening angle is reached, the disengagement of the coupling lever 20ke from the carrier 1km takes place upon further opening of the door. The free end of the locking arm 20aa arrives under the action of its reset spring in the stop position at a stop 20kha formed on the guide housing 20kh and finally in the stop position with the guide pin 20vld at the free end of the piston rod 20gks, with the result that the dead centre position is thus reset (see FIGS. 4.1, 4.1a, 4.1b and 4.2, 4.2a, 4.2b).

Modifications of the embodiment example shown in FIG. 4 are possible, in which instead of the guide housing 20kh with the slot 20khs a guide housing with a different guide is provided, preferably a guide not formed as a slot, but preferably likewise a linear guide. The guide can be formed e.g. as one or more holes in one or more transverse walls of the guide housing, in order to guide the piston rod 2gks or an element connected to the piston rod 2gks. Instead of the transverse walls with holes, guide sleeves or similar can also be provided. The guide can also be formed as one or more rails arranged extending along the guide housing 20kh. The rails can be formed as profile rails, on which guide feet or guide rollers slide. Alternatively the guide can also be formed as a ball guide.

Modifications of the embodiment examples shown in the figures are possible, in which the catching recess, which is formed in the coupling element 20ke in the embodiment examples shown in the figures, is formed on the slide arm 1ka in modified embodiments based on the embodiments in FIGS. 1 and 4 and is formed on the slider 1kag in modified embodiments based on the embodiments in FIGS. 2 and 3. In these modifications the respectively associated coupling element 20ke has a carrier, e.g. carrier pin, which interacts with the catching recess in a corresponding manner as in the embodiment examples in the figures.

1. A door drive for a door of a building with a door panel supported pivotably about a vertical door axis, in a fixed door frame, with a main drive and an auxiliary drive,
wherein the main drive is formed to act on the door panel in terms of a closing movement and/or opening movement and/or closing damping and/or opening damping; and
wherein the main drive has a drive unit with an output and a power transmission device with a slide arm and a slide rail, wherein the slide arm is drive-connected to the output of the drive unit and has at its free end a slider, with which the slide arm is guided in the slide rail, and
wherein the auxiliary drive is formed to act on the door panel in terms of a closing movement and/or an opening movement and/or closing damping and/or opening damping; and
wherein the auxiliary drive has a drive unit with an output, and
wherein the output of the drive unit of the auxiliary drive is or can be coupled to the slider and/or slide arm of the main drive via a coupling device connected in between in such a way that the slider and/or slide arm of the main drive is acted upon at least in an end phase of the closing process and/or at least an initial phase of the opening process by the output of the auxiliary drive.

2. The door drive according to claim 1, wherein the coupling device is formed to be engageable and disengageable during the closing process and/or during the opening process.

3. The door drive according to claim 1, wherein the coupling device can be controlled by the output of the drive unit of the auxiliary drive.

4. The door drive according to claim 1, wherein the coupling device has a coupling element, which can be controlled by the output of the drive unit of the auxiliary drive and is supported movably in a bearing which is supported
a) on the slide rail of the main drive or a component fixed with the slide rail of the main drive, or
b) on the output of the auxiliary drive or a component fixed with the output of the auxiliary drive.

5. The door drive according to claim 1, wherein
the coupling device has a catching recess, which can be brought into and out of engagement with a carrier element arranged on the slide arm or on the slider, forming the engaged position of the coupling device when the catching recess is in engagement with the carrier element and forming the disengaged position of the coupling device, when the catching recess is out of engagement with the carrier element; or
the coupling device has a carrier element, which can be brought into and out of engagement with a catching recess formed on the slide arm or on the slider, forming the engaged position of the coupling device when the catching recess is in engagement with the carrier element and forming the disengaged position of the coupling device when the catching recess is out of engagement with the carrier element.

6. The door drive according to claim 4, wherein the coupling element is formed as a pivot lever.

7. The door drive according to claim 6, wherein the pivot lever is formed as a two-armed lever, one end of which interacts directly or indirectly with the output of the auxiliary drive and the other end of which interacts directly or indirectly with the slider and/or slide arm of the main drive.

8. The door drive according to claim 4, wherein the coupling element formed as a one- or two-armed pivot lever assumes a dead centre position in its disengaged position and/or in the closed position of the door in its engaged position under the action of the output of the drive unit of the auxiliary drive.

9. The door drive according to claim 4, wherein the coupling element can be locked in its position disengaged from the slide arm and/or slider by a blocking device.

10. The door drive according to claim 9, wherein the blocking device has a locking lever, which is supported pivotably in a bearing fixed with the slide rail of the main drive or with the drive unit of the auxiliary drive, wherein to form a locking position of the locking lever the free end of the locking lever can be brought to stop against the output of the drive unit of the auxiliary drive or the free end can be brought to stop against the movably supported coupling element.

11. The door drive according to claim 10, wherein the locking lever is arranged in its locking position in such a way that the connecting line between the pivot bearing of the locking lever and the output is aligned with the power direction of the output of the auxiliary drive.

12. The door drive according to claim 1, wherein the output of the auxiliary drive or a component connected to the output of the auxiliary drive is guided in a guide device, wherein the guide device is formed fixed with a bearing of the drive unit of the auxiliary drive.

13. The door drive according to claim 4, wherein the coupling device has a control device, which is drive-connected to the output of the auxiliary drive and/or to the slide arm and/or slider of the main drive and acts upon the coupling element to control the coupling element.

14. The door drive according to claim 4, wherein a transmission device is connected between the coupling element and the output of the auxiliary drive to control the coupling element.

15. The door drive according to claim 12, wherein a connecting link is arranged between the output of the auxiliary drive and the coupling element, which link is guided in the guide device.

16. The door drive according to claim 12, wherein the coupling element is supported in a pivot bearing, which is formed fixed with the guide device.

17. The door drive according to claim 12, wherein the coupling element is connected in an articulated manner to one end of the connecting link, the other end of which is supported pivotably and/or displaceably in the guide housing.

18. The door drive according to claim 4, wherein the coupling device has a coupling body controlling the coupling element, which body is guided movably, acted upon by the output of the auxiliary drive, in a guide device that is fixed in terms of movement with the slide rail of the main drive and/or the drive unit of the auxiliary drive.

19. The door drive according to claim 18, wherein a shift gate device is connected between the coupling body and the coupling element, and wherein in that the coupling body has a shift gate slot and the coupling element has a shift gate pin or the coupling body has a shift gate pin and the coupling element has a shift gate slot.

20. The door drive according to claim 18, wherein the guide device of the coupling body has a shift gate slot, in which the shift gate pin of the coupling element engages or wherein the guide device of the coupling body has a shift gate pin, which engages in the shift gate slot of the coupling body and/or of the coupling element.

21. The door drive according to claim 1, wherein the output of the auxiliary drive is formed as a linear output.

22. The door drive according to claim 21, wherein the linear output is formed as a piston rod.

23. The door drive according to claim 22, wherein the piston rod forms a toggle lever configuration with the coupling element supported in an articulated manner in the engaged and/or in the disengaged position of the coupling element.

24. The door drive according to claim 1, wherein the drive unit of the auxiliary drive is formed as a gas pressure spring.

25. The door drive according to claim 1, wherein the drive unit of the auxiliary drive is arranged inside or on the outside of the slide rail of the main drive and/or a housing of the auxiliary drive fixed with the slide rail and/or inside a common housing and/or a common cover of the components of the main drive and of the auxiliary drive to be mounted on the frame side.
